(19) United States
(12) Patent Application Publication
(10) Pub. No.: US 2005/0036095 A1
(43) Pub. Date: Feb. 17, 2005

(54) Color-changeable pixels of an optical interference display panel

(76) Inventors: Jia-Jiun Yeh, San Chung City (TW); Wen-Jian Lin, Hsinchu City (TW); Hsiung-Kuang Tsai, Taipei City (TW)

Correspondence Address: GLENN PATENT GROUP, 3475 EDISON WAY, SUITE L, MENLO PARK, CA, 94025, US

(21) Appl. No.: 10/815,884

(22) Filed: Mar. 31, 2004

(30) Foreign Application Priority Data
Aug. 15, 2003 (TW) 92122564

(51) Int. Cl. G02F 1/1339

(52) U.S. Cl. 349/156

(57) ABSTRACT

A distribution density of supports and the spacing therebetween are adjusted to improve a restorability of a light-reflection electrode of a color-changeable pixel. When the spacing between the supports is decreased or the distribution density thereof is increased, a tension per unit area of the light-reflection electrode is raised. If an external force is applied to the light-reflection electrode, the tension caused by the supports will counteract the force and allow the light-reflection electrode to successfully return to the original state after the external force is removed.

### BACKGROUND

1. Field of Invention

This invention relates to a color-changeable pixel. More particularly, this invention relates to the color-changeable pixel of an optical interference display panel.

2. Description of Related Art

Due to being lightweight and small in size, a display panel is favorable in the market of the portable displays and other displays with space limitations. To date, in addition to liquid crystal display (LCD), organic electro-luminescent display (OLED) and plasma display panel (PDP) display panels, a module of the optical interference display has been investigated.

U.S. Pat. No. 5,835,255 discloses a modulator array, that is, a color-changeable pixel for visible light which can be used in a display panel. FIG. 1 illustrates a cross-sectional view of a prior art modulator. Every modulator 100 comprises two walls, 102 and 104. These two walls are supported by post 106, thus forming a cavity 108. The distance between these two walls, the depth of cavity 108, is D. The wall 102 is a light-incident electrode which, according to an absorption factor, absorbs visible light partially. The wall 104 is a light-reflection electrode, which is flexed when a voltage is applied to it.

When the incident light shines through the wall 102 and arrives at the cavity 108, only the visible light with wavelengths corresponding to the formula 1.1 is reflected back, that is,
2D=Nλ (1.1)

wherein N is a natural number.

When the depth of the cavity 108, D, equals one certain wavelength λ₁ of the incident light multiplied by any natural number, N, a constructive interference is produced and a light with the wavelength λ₁ is reflected back. Thus, an observer viewing the panel from the direction of the incident light will observe light with the certain wavelength λ₁ reflected back at him. The modulator 100 here is in an “open” state.

FIG. 2 illustrates a cross-sectional view of the modulator 100 in FIG. 1 after a voltage is applied to it. Under the applied voltage, the wall 104 is flexed by electrostatic attraction toward the wall 102. At this moment, the distance between the walls 102 and 104, the depth of cavity 108, becomes d and may equal zero.

The D in the formula 1.1 is hence replaced with d, and only the visible light with another certain wavelength λ₂ satisfying the formula 1.1 produces constructive interference within the cavity 108 and reflects back through the wall 102. However, in the modulator 100, the wall 102 is designed to have a high absorption rate for the light with the wavelength λ₂. Thus, the incident visible light with the wavelength λ₂ is absorbed, and the light with other wavelengths has destructive interference. All light is thereby filtered, and the observer is unable to see any reflected visible light when the wall 104 is flexed. The modulator 100 is now in a “closed” state.

As described above, under the applied voltage, the wall 104 is flexed by electrostatic attraction toward the wall 102 such that the modulator 100 is switched from the “open” state to the “closed” state. When the modulator 100 is switched from the “closed” state to the “open” state, the voltage for flexing the wall 104 is removed and the wall 104 elastically returns to the original state, i.e. the “open” state as illustrated in FIG. 1.

The wall 104, the light-reflection electrode, generally is a metal film of which the ability to return to an original shape after flexing depends on the elastic modulus of the metal. When the elastic modulus of the wall 104 is higher, the wall 104 can withstand greater flexing without becoming permanently deformed. The prior art method for adjusting the elastic modulus of the wall 104 to meet desired functionality is to select different alloy compositions for the metal film which comprises wall 104.

However, when the wall 104 is made of a metal film having a high elastic modulus, the metal film is not pliable during the “open-close” process, and if the metal film has a high stress, the metal film often easily delaminates during a coating process or other subsequent processes. Furthermore, changing the alloy composition of the wall 104 may also affect how reliable the pixel functions. Therefore, a color-changeable pixel and the manufacturing method thereof is needed, of which a metal film can be used which has a low elastic modulus and suitable thin film stress yet is able to revert to a previous shape after flexing thereby mitigating the film delamination and improving the reliability of the prior art modulator 100 as described above.

### SUMMARY

It is therefore an objective of the present invention to provide a color-changeable pixel for an optical interference display panel to mitigate the film delamination and improve the reliability of the prior art modulator as described above.

It is another an objective of the present invention to provide a color-changeable pixel for an optical interference display panel, in which a metal film with low elastic modulus is selected to manufacture the color-changeable pixel such that it is highly capable of reverting to a previous shape after flexing, that is, it has a high restorability.

It is still another objective of the present invention to provide a color-changeable pixel for an optical interference display panel, in which a distribution density of supports is adjusted to raise a tension per unit area of the light-reflection electrode thereof.

In accordance with the foregoing and other objectives of the present invention, a color-changeable pixel for an optical interference display panel is provided. A distribution density of supports and the spacing therebetween are adjusted to improve the restorability of a light-reflection electrode of the color-changeable pixel. When the spacing between the supports is decreased or the distribution density thereof is increased, a tension per unit area of the light-reflection electrode is raised. If an external force is applied to the light-reflection electrode, the tension caused by the supports will counteract the force and allow the light-reflection electrode to successfully return to the original state after the external force is removed.

According to one preferred embodiment of the invention, the supports are a plurality of posts, in which spacing is between one post and another post, and the posts are arrayed to form an active region. A range of the distribution density of the supports, defined as a quantity of the posts per unit area, is between 225 posts per square millimeter and 2500 posts per square millimeter. The preferred range of the distribution density is between 400 posts per square millimeter and 2500 posts per square millimeter.

A material of the supports is a photosensitive material, such as a photoresist; or a non-photosensitive material, such as polyester or polyamide. According to other preferred embodiments of the invention, the material suitable for the supports includes a positive photoresist, a negative photoresist, and polymers, such as an acrylic resin or an epoxy resin.

The distribution density of supports is adjusted to efficiently improve the restorability of the light-reflection electrode of the color-changeable pixel. The color-changeable pixel of the invention can use a metal film with a low elastic modulus and suitable thin film stress to manufacture the light-reflection electrode having high restorability. Therefore, the invention prevents the film delamination and the reliability issues of the prior arts.

In addition, the invention also avoids the long development time and the high manufacturing cost inherent to designing a metal film which has both a high elastic modulus and a suitable thin film stress therefore does not easily delaminate. By employing the invention, conventional and inexpensive metal films can also be used to manufacture a color-changeable pixel having sufficient restorability.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 illustrates a cross-sectional view of a prior art modulator;

FIG. 2 illustrates a cross-sectional view of the modulator 100 in FIG. 1 after a voltage is applied to it;

FIG. 3 illustrates a top view of a color-changeable pixel of one preferred embodiment of the invention; and

FIGS. 4A to 4B depict a method for manufacturing a color-changeable pixel according to one preferred embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The invention adjusts the distribution density of supports and the spacing therebetween of the color-changeable pixel to improve the ability to revert to an original shape, i.e. the restorability, of the light-reflection electrode. When the spacing between the supports is decreased or the distribution density thereof is increased, a tension per unit area of the light-reflection electrode is raised. If an external force is applied to the light-reflection electrode, the tension caused by the supports will counteract the force and allow the light-reflection electrode to successfully return to the original state after the external force is removed. Thus, the restorability of the light-reflection electrode is substantially improved by adjusting the distribution density of the supports, not by using a material with a high elastic modulus or high stress to manufacture it as before, thereby successfully avoiding the film delamination and the reliability issues of the prior art.

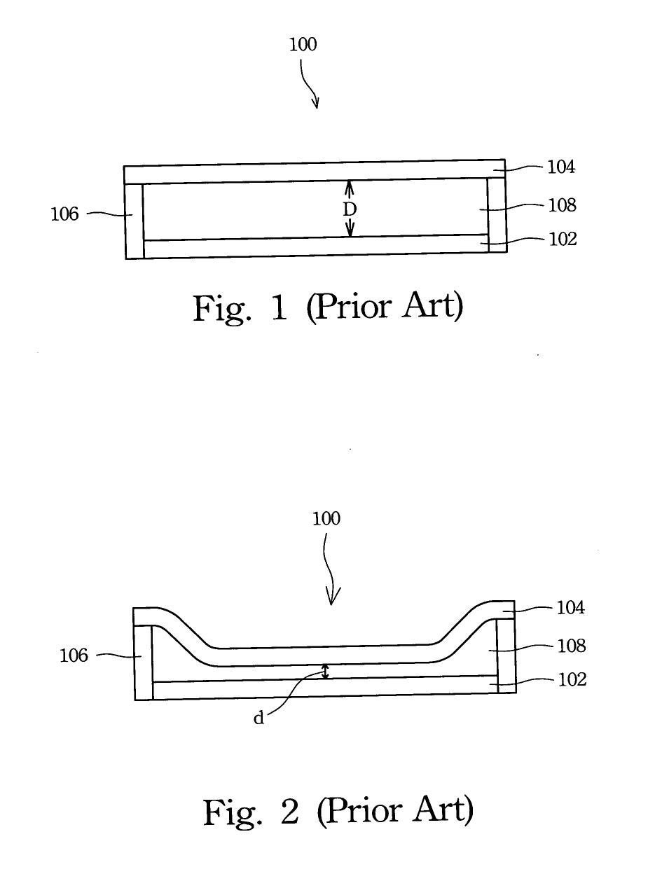

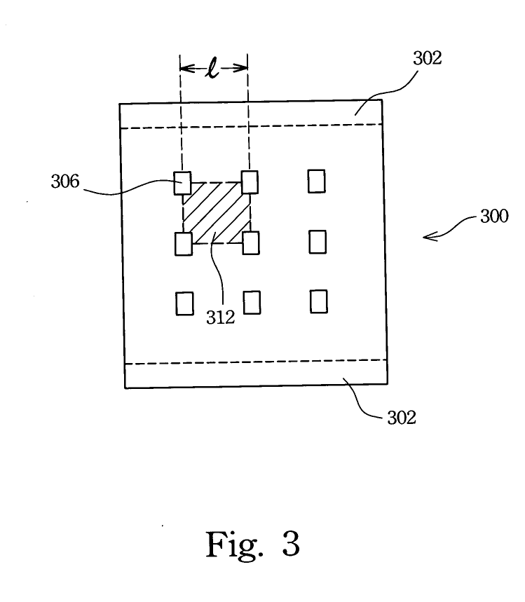

FIG. 3 illustrates a top view of a color-changeable pixel of one preferred embodiment of the invention. As illustrated in FIG. 3, the color-changeable pixel 300 has separation structures 302, separately positioned at two opposite sides of the color-changeable pixel 300. In this embodiment, the supports inside the color-changeable pixel 300 are a plurality of posts 306, denoted as small squares in FIG. 3, but can be designed as any other form in practice. The separation structures 302 and the posts 306 are located between the light-incident electrode and the light-reflection electrode (i.e. the wall 102 and the wall 104 in FIG. 1). A spacing l is between one post 306 and another post 306, and the posts are thus arrayed to form an active region 312.

The preferred embodiment adjusts the distribution density of posts 306 and the spacing l therebetween to improve the restorability of the light-reflection electrode of the color-changeable pixel 300.

According to one example of this preferred embodiment, the size of the color-changeable pixel 300 is 204 μm×204 μm, and the posts 306 are arrayed therein. When a quantity of the posts 306 is 3×3, the l between every two adjacent posts 306 is about 50 μm, thereby producing a restorability of the light-reflection electrode that is very small. When the quantity of the posts 306 is 4×4, the l between every two adjacent posts 306 is about 40 μm, and the restorability of the light-reflection electrode is then increased. When the quantity of the posts 306 is 5×5, the l between every two adjacent posts 306 is about 30 μm, and the restorability of the light-reflection electrode is increased substantially. The above descriptions of the posts and spacing therebetween are listed in Table 1.

TABLE 1
A comparison of different quantities of the posts in the
color-changeable pixel.

| The quantity of | The spacing | The area of the active | The density per |
|---|---|---|---|
| the posts 306 | (μm) | region 312 (μm²) | unit area (mm⁻²) |
| 3 × 3 | 50 | 2500 | 225 |
| 4 × 4 | 40 | 1600 | 400 |
| 5 × 5 | 30 | 900 | 625 |

As illustrated in Table 1, when the quantity of the posts 306 is greater, the spacing therebetween is smaller, the area of the active region 312 is smaller, and the quantity of the posts per unit area is greater, that is, the distribution density per unit area is larger. According to another preferred embodiment of the invention, when considering the yield strength of the light-reflection electrode and the aperture rate of the color-changeable pixel, the spacing l can be reduced to about 20 μm. The quantity of the posts per unit area, the density per unit area, can thus reach about 2500 per square millimeter (2500 mm⁻²). Then, the light-reflection electrode of the color-changeable pixel 300 is supported by the most posts 306, and the restorability is larger than those of the other examples.

The supports in the preferred embodiments are posts. However, other supports of different types, such as a grid of crisscrossed lines, are also able to be used in the invention and are not limited by the preferred embodiment. The distribution density of the supports dominates the supporting force thereof to the active region of the light-reflection electrode. When the density of the supports per unit area is larger, the restorability per unit area is larger. In other words, if employing the above grid design, when the grid supports are denser, the restorability is larger.

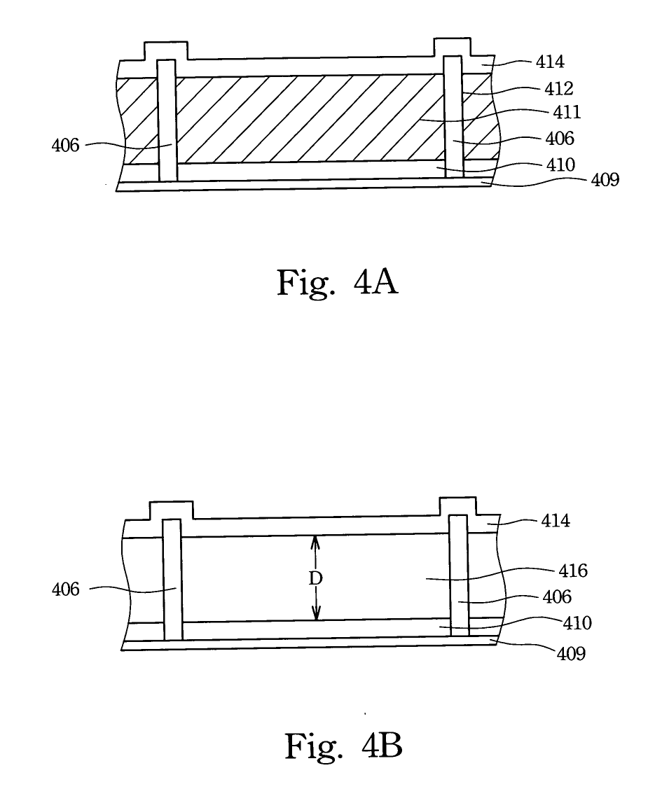

FIGS. 4A to 4B depict a method for manufacturing a color-changeable pixel according to a preferred embodiment of the invention. Reference is made to FIG. 4A first, in which a first electrode 410 and a sacrificial layer 411 are formed in order on a transparent substrate 409. The sacrificial layer 411 may be made of transparent materials such as dielectric materials, or be made of opaque materials such as metal materials, polysilicon or amorphous silicon (a-Si). In this preferred embodiment, the material of the sacrificial layer 411 is amorphous silicon.

Openings 412 are formed in the first electrode 410 and the sacrificial layer 411 by a photolithographic etching process. Every opening 412 is suitable for forming a post 406 therein. The openings 412 of the preferred embodiment are formed with a predetermined density, and the density of the openings 412 can be changed to adjust the restorability of the color-changeable pixel.

Next, a material layer (not illustrated in FIG. 4A) is formed in the sacrificial layer 411 and fills the openings 412. The material layer is suitable for forming posts 406 and generally uses photosensitive materials such as photoresists, or non-photosensitive polymeric materials such as polyester, polyamide or the like. If the non-photosensitive materials are used for forming the material layer, an additional photolithographic etching process is required to define posts 406 in the material layer. In this embodiment, the photosensitive materials are used for forming the material layer, so merely a single photolithographic etching process is required for patterning the material layer.

A second electrode 414 is formed on the sacrificial layer 411 and the posts 406. Reference is made to FIG. 4B, in which the sacrificial layer 411 is removed by a release etching process, such as a remote plasma etching process, to form a cavity 416. The depth D of the cavity 416 is the thickness of the sacrificial layer 411. The remote plasma etching process etches the sacrificial layer 411 with a remote plasma produced by an etching reagent having a fluorine group or a chlorine group, such as CF4, BCl3, NF3, or SF6, as a precursor.

In this invention, the materials suitable for forming posts 406 include positive photoresists, negative photoresists, and all kinds of polymers such as acrylic resins and epoxy resins.

The distribution density of supports is adjusted to efficiently improve the restorability of the light-reflection electrode of the color-changeable pixel. The color-changeable pixel of the invention can employ a metal film with a low elastic modulus and suitable thin film stress to manufacture the light-reflection electrode having large restorability. Therefore, the invention prevents the film delamination and the reliability issues of the prior arts.

In addition, the invention also avoids the long development time and the high manufacturing cost inherent to designing a metal film which has both a high elastic modulus and a suitable thin film stress therefore does not easily delaminate. By employing the invention, conventional and inexpensive metal films can also be used to manufacture a color-changeable pixel having sufficient restorability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A color-changeable pixel comprising:
a first electrode;
a second electrode, wherein the second electrode is a moveable electrode and is seated in parallel with the first electrode substantially; and
a plurality of supports, located between the first electrode and the second electrode, wherein a restorability of the second electrode is adjusted by a distribution density of the supports.

2. The color-changeable pixel of claim 1, wherein when the supports are a plurality of posts, the distribution density of the supports is a quantity of the posts per unit area.

3. The color-changeable pixel of claim 2, wherein a range of the distribution density is between 225 posts per square millimeter and 2500 posts per square millimeter.

4. The color-changeable pixel of claim 2, wherein a preferred range of the distribution density is between 400 posts per square millimeter and 2500 posts per square millimeter.

5. The color-changeable pixel of claim 1, wherein the supports are grid supports.

6. The color-changeable pixel of claim 1, wherein a material of the supports is a photosensitive material or a non-photosensitive material.

7. The color-changeable pixel of claim 1, wherein a material of the supports is a photoresist.

8. The color-changeable pixel of claim 1, wherein a material of the supports is polyester or polyamide.

9. The color-changeable pixel of claim 1, wherein a material of the supports is an acrylic resin or an epoxy resin.
